(19) United States
(12) Patent Application Publication
(10) Pub. No.: US 2020/0198587 A1
(43) Pub. Date: Jun. 25, 2020

(54) VEHICLE WIPER CONTROL SYSTEM FOR TARGET AREA CLEANING

(71) Applicant: GM Global Technology Operations LLC, Detroit, MI (US)

(72) Inventors: Xinyu Du, Oakland Township, MI (US); Paul E. Krajewski, Troy, MI (US)

(21) Appl. No.: 16/225,101

(22) Filed: Dec. 19, 2018

(51) Int. Cl. B60S 1/08; B60S 1/34

(52) U.S. Cl. CPC B60S 1/0844; B60S 1/3415

(57) ABSTRACT

A method of monitoring a windshield of a vehicle including: capturing an image of a windshield of a vehicle; determining that debris is located on the windshield in response to the image of the windshield; determining a location of the debris on the windshield; determining to remove the debris from the windshield; and actuating a drive motor of a wiper system to clean the location, the drive motor being operably connected to a wiper arm having a wiper blade.

### INTRODUCTION

The subject disclosure relates to vehicles, and more particularly relates to methods and systems for monitoring a windscreen or a windshield of a vehicle.

A wiper blade is a device used to remove rain and debris from a windscreen or a windshield. Almost all vehicles, including trains, watercraft, and some aircraft, are equipped with such wipers. A wiper blade generally includes an arm that is pivotally attached to the vehicle at one end and that has blade attached to the other end. The arm is controlled to pivot back and forth at varying rates to cause the blade to swing back and forth over the glass. The blade moves along the surface of the windshield in order to push water from its surface.

Due to the frequent exposure to environmental factors, the visibility through the windscreen or windshield may be impaired by debris to an extent that normal operation of the wiper blade may have difficulty removing the debris. The debris must then be removed manually by a human being. If the vehicle is self-driving, manual removal by a human being may not be attainable for a certain period of time.

Accordingly, it is desirable to provide methods and system for monitoring debris accumulation on a windscreen or a windshield of a vehicle and removing the debris.

### SUMMARY

In one exemplary embodiment, a method of monitoring a windshield of a vehicle is provided. The method includes that an image of a windshield of a vehicle is captured. The method also includes that debris is determined to be located on the windshield in response to the image of the windshield. The method further includes that a location of the debris on the windshield is determined. The method may yet further include that it is determined to remove the debris from the windshield. The method also includes that a drive motor of a wiper system is actuated to clean the location, the drive motor being operably connected to a wiper arm having a wiper blade.

In addition to one or more of the features described herein, or as an alternative, further embodiments may include that the location of the debris is determined to be between a first swipe angle of the wiper arm and a second swipe angle of the wiper arm. The drive motor actuates the wiper arm ad the wiper blade between the first swipe angle of the wiper arm and a second swipe angle of the wiper arm.

In addition to one or more of the features described herein, or as an alternative, further embodiments may include that determining to remove the debris from the windshield further includes that a notification on a notification device indicating debris is located on the windshield is activated. Additionally, determining to remove the debris from the windshield further includes that a selection input from an input device to remove the debris from the windshield is received.

In addition to one or more of the features described herein, or as an alternative, further embodiments may include that determining to remove the debris from the windshield further includes that a visibility through the windshield in response to the debris detected is determined. Additionally, determining to remove the debris from the windshield further includes that the visibility through the windshield is less than a desired visibility is determined.

In addition to one or more of the features described herein, or as an alternative, further embodiments may include that a type of the debris is determined.

In addition to one or more of the features described herein, or as an alternative, further embodiments may include that at least one of speed and duration of the drive motor is adjusted in response to the type of debris.

In addition to one or more of the features described herein, or as an alternative, further embodiments may include that a heating ventilation and air conditioning of the vehicle is activated in response to the type of debris.

In addition to one or more of the features described herein, or as an alternative, further embodiments may include that a wiper fluid spray system is activated in response to the type of debris.

In addition to one or more of the features described herein, or as an alternative, further embodiments may include that a size of the debris is determined.

In addition to one or more of the features described herein, or as a alternative, further embodiments may include that at least one of a speed and duration of the drive motor is adjusted in response to the size of debris and a wiper fluid spray system in response to the size of debris is activated.

In addition to one or more of the features described herein, or as an alternative, further embodiments may include that a selection input from an input device to stop actuating the drive motor is received.

In addition to one or more of the features described herein, or as an alternative, further embodiments may include that a second image of the windshield of the vehicle is captured. Additionally, It may be determined that debris has been removed from the windshield in response to the second image of the windshield and the drive motor of the wiper system may be stopped.

In another exemplary embodiment, a method of monitoring health of a wiper system of a vehicle is provided. The method of monitoring health of a wiper system of a vehicle includes that a wiper system of a vehicle is activated for a selected period of time. The method may also include that an image of a windshield of the vehicle is captured. The method may further include that a health of the wiper system is determined in response to the image of the windshield of the vehicle. The method may yet further include that a notification is activated in response to the health of the wiper system.

In addition to one or more of the features described herein, or as an alternative, further embodiments may include that activating the wiper system of the vehicle further includes that actuation of a drive motor of the wiper system is commanded to actuate a wiper arm to a desired actuation position. The image of the windshield of the vehicle captures an actual actuation position of the wiper arm.

In addition to one or more of the features described herein, or as a alternative, further embodiments may include that determining a health of the wiper system in response to the image of the windshield of the vehicle further includes that the actual actuation position of the wiper arm is compared to a desired actuation position and a health of the wiper motor is determined in response to comparing the actual actuation position of the wiper arm to a desired actuation position.

In addition to one or more of the features described herein, or as an alternative, further embodiments may include that activating the wiper system of the vehicle further includes that actuation of a wiper fluid spray system of the wiper system is commanded to spray the windshield with a desired amount of wiper fluid. The image captures an actual amount of wiper fluid sprayed onto the windshield.

In addition to one or more of the features described herein, or as an alternative, further embodiments may include that determining a health of the wiper system in response to the image of the windshield of the vehicle further includes that the actual amount of wiper fluid sprayed onto the windshield is compared to the desired amount of wiper fluid and a health of the wiper fluid spray system is compared in response to comparing the actual amount of wiper fluid sprayed onto the windshield to the desired amount of wiper fluid.

In addition to one or more of the features described herein, or as an alternative, further embodiments may include that the image of the windshield of the vehicle is captured after the selected period of time and that the method further includes that a health of a wiper blade of the wiper system is determined in response to the image.

In addition to one or more of the features described herein, or as an alternative, further embodiments may include that determining a health of a wiper blade of the wiper system in response to the image further includes that a visibility through the windshield is determined in response to the image and the visibility through the windshield is compared to a desired visibility.

In addition to one or more of the features described herein, or as an alternative, further embodiments may include that the image of the windshield of the vehicle is captured after the selected period of time, and that determining a health of the wiper system in response to the image of the windshield of the vehicle further includes that a visibility through the windshield is determined in response to the image and the visibility through the windshield is compared to a desired visibility.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of a part of a vehicle that includes, among other features, a wiper blade monitoring system, according to an embodiment of the present disclosure;

FIG. 2 is a is a flow diagram illustrating a method of monitoring a windshield of a vehicle, according to an embodiment of the present disclosure; and

FIG. 3 is a flow diagram illustrating a method of monitoring health of a wiper system of a vehicle, according to an embodiment of the present disclosure.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, exemplary embodiments may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that exemplary embodiments may be practiced in conjunction with any number of control systems, and that the vehicle systems described herein are merely exemplary embodiments.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in various embodiments.

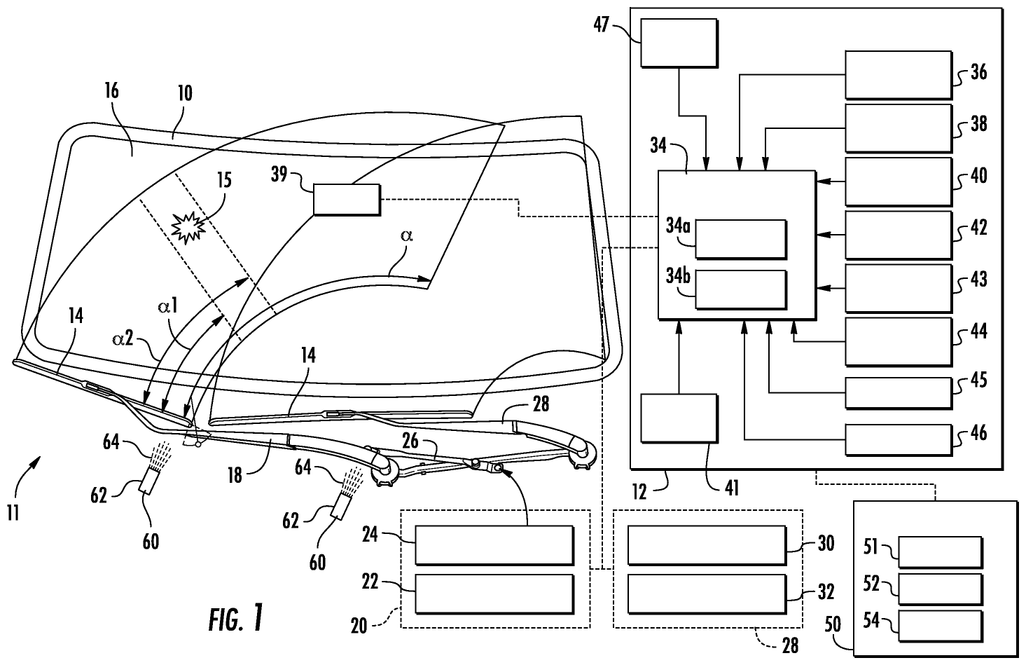

Referring now to FIG. 1, in accordance with an exemplary embodiment a vehicle 10 is shown to include a windshield monitoring system 12 that monitors a wiper system 11, among other components of the vehicle 10 in order to monitor and clean debris from a windshield 16. Although the figures shown herein depict an example with certain arrangements of elements, additional intervening elements, devices, features, or components may be present in actual embodiments. It should also be understood that FIG. 1 is merely illustrative and may not be drawn to scale.

As depicted in FIG. 1, the wiper system 11 generally includes one or more wiper blades 14, one or more wiper arm 18, a wiper fluid spray system 60, a drive mechanism 20, a wiper blade control system 28, and a windshield monitoring system 12. As can be appreciated, the vehicle 10 may be any vehicle type including a passenger vehicle, an automobile, autonomous vehicle, a semi-autonomous vehicle, a fully autonomous vehicle, an aircraft, a train, a watercraft, or any other vehicle type that includes a wiper blade 14. For exemplary purposes, the disclosure will be discussed in the context of the vehicle 10 being a passenger vehicle having a wiper blade 14 associated with a windshield 16 of the passenger vehicle. As can also be appreciated, the windshield 16 may be any vehicle surface including a front windshield, a rear windshield, a head lamp, a tail lamp, a camera lens, a camera windshield, a window, a LIDAR system, a RADAR system, sunroof, moonroof, panoramic roof, glass roof, or any other surface that may be cleaned by a wiper blade 14. For exemplary purposes, the disclosure will be discussed in the context of the windshield 16 being a front windshield of a vehicle 10 having a wiper blade 14 associated with the windshield 16.

As shown in FIG. 1, the wiper fluid spray system 60 includes a nozzle 62 configured to spray wiper fluid 64 onto the windshield 16. Although not shown for ease of illustration, the wiper nozzle 62 is fluidly connected to a wiper fluid tank where the wiper fluid 64 is stored. As shown in FIG. 1, the pivotal movement of the wiper arm 18 is driven by a drive mechanism 20. The drive mechanism 20 generally includes a power source 22 and a drive motor 24. In operation, power is supplied from the power source 22 to the drive motor 24 and the drive motor 24 drives the pivotal movement of the wiper arm 18 (e.g., via a drive pilot and linkage mechanism 26, or other coupling devices (not shown)).

In various embodiments, a position, a frequency, or a speed of the pivotal movement of the wiper arm 18 is controllable by the wiper blade control system 28. For example, the wiper blade control system 28 includes a control module 30 that controls the drive motor 24 to vary the frequency or speed of the movement of the wiper arms 18. For example, the wiper blade control system 28 may include a control module 30 that controls the drive motor 24 to control the position of the wiper arm. The wiper blade control system 28 may further include a user input device 32 (e.g., a switch or other device) that is able to be manipulated by a user to select the speed or frequency of the movement of the wiper arms 18. As the control module 30 receives input from the user input device 32, the control module 30 controls the power supplied to the drive motor 24 based on the selection of the speed or frequency via the user input device 32.

The windshield monitoring system 12 generally includes a control module 34. The control module 34 may be an electronic controller including a processor 34a and an associated memory 34b comprising computer-executable instructions that, when executed by the processor 34a, cause the processor 34a to perform various operations. The processor 34a may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 34b may be but is not limited to a random access memory (RAM), read only memory (ROM), or other electronic, optical, magnetic or any other computer readable medium.

The control module 34 may be integrated with the control module 30 of the wiper blade control system 28, or may be implemented as another module and may communicate with the control module 30 (as shown). The control module 34 is communicatively coupled to one or more sensors 36-44, and one or more information systems 44-46. The sensors 36-44 sense observable conditions of the wiper blade 14 and/or of the vehicle 10. The sensors 36-44 may include but are not limited to a camera 39, a humidity sensor 36, a light sensor 38, a temperature sensor 40, a wiper motor sensor 42, wiper proximity sensor 43, an angle sensor 44, and a wiper fluid sensor 41.

The camera 39 captures images of the windshield 16 to determine visibility through the windshield. The humidity sensor 36 senses a humidity of the ambient air and generates sensor signals based thereon. The light sensor 38 senses ambient light (e.g., ultraviolet or otherwise) and generates sensor signals based thereon. The temperature sensor 40 senses ambient temperature and generates sensor signals based thereon. The wiper motor sensor 42 senses a voltage and/or a current of the drive motor 24 and generates sensor signals based thereon. The wiper proximity sensor 43 senses whether the wiper blades 14 are present and engaged and generates sensor signals based thereon. The angle sensor 44 senses an angle of the wiper arm and generates sensor signals based thereon. The wiper fluid sensor 41 monitors the use of wiper fluid on the windshield 16 and how much wiper fluid 64 remains to be used.

The information systems 45-47 provide vehicle information to the control module 34, directly or indirectly, through a communication bus (not shown). The information system 45-47 may include but are not limited to a global positioning information system (GPS) 45, a vehicle calendar information system 46, and a heating ventilation and air conditioning (HVAC) system 47.

The GPS 45 provides location information such as coordinates or region information. The vehicle calendar information system 46 provides calendar information such as a current date and/or a current time. The HVAC system 46 HVAC system information such as whether a front defroster is activated for the windshield 16.

The control module 34 monitors the usage of the wiper blade 14 based on the received signals from the sensors 36-44 and/or the data from the information systems 44-47. The control module 34 may determine a visibility through the windshield 16 in response to the received signals and data. The control module 34 may also determine a health of the wiper blade 14 in response to the received signals and data. The control module 34 may also generate a status (e.g., empty wiper fluid 64) of a wiper fluid spray system 60 in response to the received signals and data. The control module 34 may generate notification data to notify a user of the visibility through the windshield 16, the health of a wiper blade 14, or the wiper fluid spray system 60. The notification data is received by user device 50 having a display device 51, audio device 52, and/or a haptic device 54, and is used to issue notifications to the user. The user device 50 may be a computing device, such as, for example, a vehicle dashboard monitor, a smart phone, a smart watch, a desktop computer, a laptop computer, a tablet, an alert light on a vehicle, center stack, infotainment system, or any similar notification device known to one of skill in the art. As can be appreciated, the notification can be any type of notification including an audio notification, a visual notification, and/or a haptic notification. In one example, the notification may indicate the windshield 16 needs manual cleaning by a human being. In another example the notification may indicate a component of the wiper system 11 is operating abnormally.

The windshield monitoring system 12 monitors conditions associated with visibility through the windshield 16 and may adjust operation of the wiper arm 18 in response thereto. The windshield monitoring system 12 is m electronic communication with the camera 39 that detects visibility through the windshield 16. The camera 39 may be located within the vehicle 10 looking through the windshield 16 or the camera may be located outside the vehicle 10 looking at the windshield 16. Debris 15 located on the windshield 16 may impair or reduce visibility through the windshield 16. Debris 15 may include but is not limit to rain, snow, frost, ice, dust, dirt, mud, bird droppings, tree sap, leaves, oil, brake dust, smog, smoke, pollution, or any other matter that may accumulate on a windshield 16.

The camera 39 may capture images of the debris 15 on the windshield 16 and transmit the images to the windshield monitoring system 12. The windshield monitoring system 12 uses image processing (e.g., machine learning) to analyze the images to determine the location of the debris 15 on the windshield and degree of accumulation of the debris 15 on the windshield 16. The image processing may include training a software model, such as, for example, CNN/Fast R-CNN model or a similar model to detect different types of debris 15 and accumulation of debris 15. Image processing may include comparing the images captured by the camera 39 to stock images of a clean windshield 16. The windshield monitoring system 12 may also determine the type of debris 15 through image processing. Image processing may include comparing the images captured by the camera 39 to stock images of different types of debris 15 located on the windshield 16. Different types of debris 15 may have different colors, sizes, or splatter patterns. The windshield monitoring system 12 may also determine the type of debris 15 through an image processing, such as, for example, CNN/Fast R-CNN model that uses a plurality of stock images of different types of debris 15 located on the windshield 16 to train a CNN/Fast R-CNN model. Once the CNN/Fast R-CNN model is trained then, when provided with an image of the debris 15 on the windshield 16 for analysis, the CNN/Fast R-CNN model can determine the type of debris 15 and the location of the debris. Once the CNN/Fast R-CNN model is trained, the memory 34b need not store the stock images that were used for training. The windshield monitoring system 12 may also utilize other data to determine the type of the debris 15. For example, the time of year from the calendar information system 46, the location of the vehicle 10 from the GPS 45, and whether the windshield defroster is activated from the HVAC system 47 may all help indicate that the ambient whether conditions are ripe for ice formation on the windshield and there is a high probably that the debris 15 is ice.

The windshield monitoring system 12 may determine the location and degree of accumulation (I.e., amount or quantity) of the debris 15 on the windshield 16 and adjust operation of the wiper arm 18 to target its specific location and degree of accumulation. For example, a wiper arm 18 may normally operate through a full swipe angle α but if the camera 39 detects that debris 15 is located between a first swipe angle α1 and a second swipe angle α2 then the windshield monitoring system 12 may actuate the drive motor 24 to swipe between the first swipe angle α1 and the second swipe angle α2 rather than the full swipe angle α. Depending upon the degree of accumulation of debris 15 the windshield monitoring system 12 may also adjust the speed of the drive motor 24 between the first swipe angle α1 and the second swipe angle α2. For example, a larger amount of debris 15 or debris that is more tightly adhered to the windshield 16 may require faster swiping by the wiper blades 14. The windshield monitoring system 12 may monitor and control the angle of the wiper arm 18 using the wiper arm angle sensor 44 and the wiper motor sensor 42, as discussed above.

The windshield monitoring system 12 may also monitor the health of the wiper blades 14 by monitoring how well the wiper blades clean. For example, was the debris 15 completely cleared, how long did it take to clear the debris compared to how long it should have taken to clear the debris with a healthy wiper blade, are there streaks left on the windshield 16 from the wiper blade 14, etc. When the drive mechanism 20 of the wiper arm 18 is activated, the camera 39 may continuously capture images as the debris 15 is being removed from the windshield by the wiper blades 14.

The windshield monitoring system 12 uses image processing (e.g., machine learning) to analyze each image captured during the wiper cleaning process to determine, whether the position of the wiper arm 18 was as commanded, whether the amount of wiper fluid 64 was as commanded, how long it took the wiper blades 14 to remove the debris 15 from the windshield 16, and the visibility through the windshield after the cleaning process has been completed. Fully healthy wiper blades 14 may clean the windshield 16 leaving behind little to no debris 15 while wiper blades with a reduced health or little life remaining may leaving streaks on the windshield and/or may not remove the debris from the windshield. The health of the wiper blade 14 may be measured in terms of a percentage of remaining life. For example, a blade with a 100% remaining life may be a healthy wiper blade while a wiper blade 14 with 0% remaining life may need to be replaced. The image processing may include training a CNN/Fast R-CNN model to detect different types of debris 15, accumulation of debris, removal of debris, and streaks from wiper blades 14. Image processing may include using a trained a CNN/Fast R-CNN model and/or comparing the images captured by the camera 39 to stock images of a windshield 16 cleaned by a healthy wiper blade with 100% remaining life, stock images of a windshield cleaned by an unhealthy blade with 0% remaining life, and a windshield cleaned by wiper blades 14 that are between a healthy wiper blade with 100% remaining life and an unhealthy wiper blade with 0% remaining life.

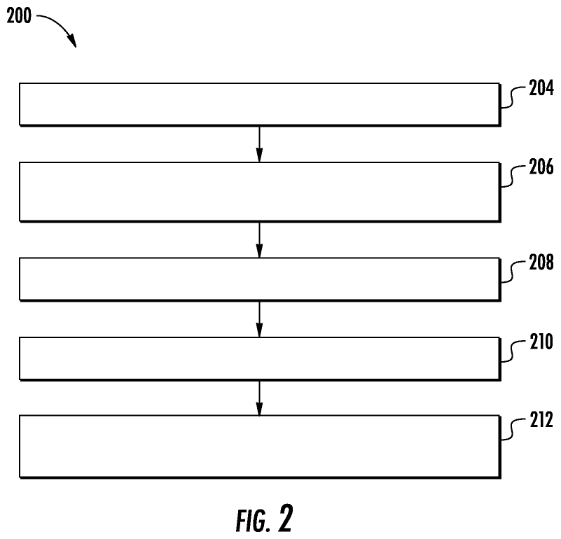

Referring now to FIG. 2, with continued reference to FIG. 1, a flow chart is illustrated of a method 200 of monitoring a windshield 16 of a vehicle 10, according to an embodiment of the present disclosure. In an embodiment, the method 200 is performed by the windshield monitoring system 12. At block 204, an image of a windshield 16 of a vehicle 10 is captured using a camera 39.

At block 206, it is determined that debris 15 is located on the windshield 16 in response to the image of the windshield. It may be determined that debris 15 is located on the windshield 16 using image processing, as discussed above. The location of the debris 15 may be determined to be between a first swipe angle α1 of the wiper arm 18 and a second swipe angle α2 of the wiper arm, as shown in FIG. 1. At block 208, a location of the debris 15 on the windshield 16 is determined. The location of the debris 15 on the windshield may be determined using the image of the windshield 16 captured by the camera 39 and image processing. The location of the debris 15 may be determined to be between a first swipe angle α1 of the wiper arm 18 and a second swipe angle α2 of the wiper arm, as shown in FIG. 1. The location determined 208 is a precise location on the windshield, as opposed to just determining that debris is located on the windshield in block 206

At block 210, it is determined to remove the debris 15 from the windshield 16. If the wiper system 11 is being manually controlled by a human being then it may be determined to remove the debris 15 from the windshield 16 by: activating a notification on a notification device indicating debris 15 is located on the windshield 16; and receiving a selection input from an input device 32 to remove the debris 15 from the windshield 16. If the wiper system 11 is being autonomously controlled (e.g., in an autonomous vehicle) then it may be determined to remove the debris 15 from the windshield 16 by: determining a visibility through the windshield 16 in response to the debris 15 detected; and determining that the visibility through the windshield 16 is less than a desired visibility. In the case of an autonomous vehicle, the windshield 16 may protect autonomous driving sensors and thus visibility may be greater than the desired visibility for a human driver in order for the autonomous sense to function properly. The windshield monitoring system may also factor into account how much wiper fluid 64 is remaining, such that the wiper fluid 64 may be rationed accordingly for the remainder of a trip.

At block 212, a drive motor 24 of a wiper system 11 is actuated to clean the location. The location may be the entire swipe angle α or a portion of the swipe angle α. The drive motor 24 may actuate the wiper arm 18 and the wiper blade 14 between the first swipe angle α1 of the wiper arm and the second swipe angle α2 of the wiper arm, thus focusing exclusively on the location of the debris 15. Additionally, the speed of the drive motor 24 may be adjusted between the first swipe angle α1 of the wiper arm 18 and the second swipe angle α2 of the wiper arm. For example, the speed of the drive motor 24 may be adjusted between the first swipe angle α1 of the wiper arm 18 and the second swipe angle α2 of the wiper arm, such that the blade 14 is accelerating or decelerating as the blade 14 strikes the debris 15. As discussed above, the drive motor 24 is operably connected to a wiper arm 18 having a wiper blade 14. The drive motor 24 may be stopped automatically when it is determined that the windshield 16 is clean or a selection input may be received from an input device 32 to stop actuating the drive motor 24.

The method 200 may also comprise that a type of the debris 15 located on the windshield 16 is determined through image processing. The actuation of the drive motor 24 may be adjusted in response to the type of debris. The type of debris 15 may determine the speed of the actuation of the drive motor 24 and also the duration of the actuation of the drive motor. For example, stickier debris 15 may require faster actuation of drive motor 24 while less sticky debris may respond better to slower actuation of the drive motor. In another example, if debris 15 is difficult to remove, then at least one of the speed of the actuation of the drive motor 24 may be increased and the wiper fluid 64 usage may be increased. Additionally, debris 15 of a certain type may require the drive motor 24 to be actuated for a longer period of time than debris of another type.

The HVAC system 47 may be activated in response to the type of debris 15. For example, if the debris 15 is determined to be ice, then the HVAC system 47 may activate a defroster for the windshield 16. A wiper fluid spray system 60 may be activated in response to the type of debris 15. The type of debris 15 may also determine the quantity of wiper fluid 64 used. For example, stickier debris 15 (e.g., bird poop, mud, or tree sap) may require wiper fluid to loosen the debris from the windshield while non-sticky debris 15 may simply be removed by the wiper blade 14 without wasting wiper fluid 64.

The method 200 may further comprise: determining a size (i.e., quantity) of the debris 15. The actuation of the drive motor 24 may be adjusted in response to the size of debris 15. The size of debris 15 may determine the speed of actuation of the drive motor 24 and also the duration of actuation of the drive motor 24. In one example, debris 15 larger in size may require the drive motor 24 to be actuated for a longer period of time than debris of a smaller size. In another example, debris 15 smaller in size may be removed quickly with faster actuation whereas debris larger in size may be best removed with slower actuation. A wiper fluid spray system 60 may be activated in response to the size of debris 15. The size of debris may determine the quantity of wiper fluid 64 used. For example, large amount on debris 15 may require a large amount of wiper fluid 64 to loosen the debris from the windshield 16 while a smaller amount of debris may require less wiper fluid.

The method 200 may additionally comprise that a second image of a windshield 16 of a vehicle 10 is captured and it is determined that determine that debris 15 has been removed from the windshield in response to the second image of the windshield 16. The drive motor 24 of the wiper system 11 may then be stopped. It is understood that the method may include continuous capture of a plurality of images in real time.

While the above description has described the flow process of FIG. 2 in a particular order, it should be appreciated that unless otherwise specifically required in the attached claims that the ordering of the steps may be varied.

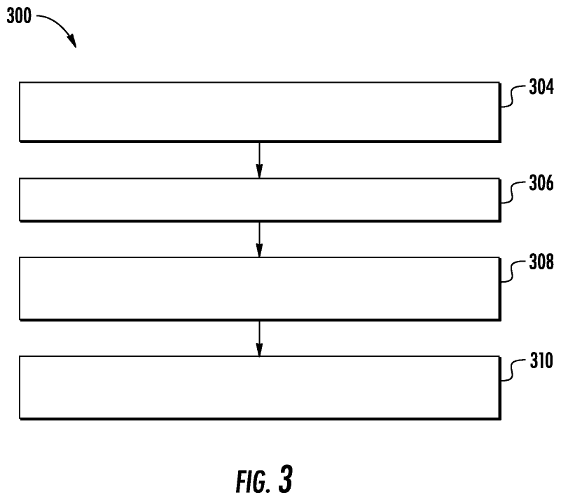

Referring now to FIG. 3, with continued reference to FIG. 1, a flow chart of a method 300 of monitoring a health of a wiper system 11 of a vehicle 10 is shown, according to an embodiment of the present disclosure. In an embodiment, the method 300 is performed by the windshield monitoring system 12. At block 304, a wiper system 11 of a vehicle 10 is activated for a selected period of time. The wiper system of the vehicle may activate the drive motor 24 for a desired speed and to a desired position. The wiper system may activate the wiper fluid spray system 60 to spray the windshield 16 with a desired amount of wiper fluid 64. At block 306, an image of the windshield 16 is captured. As discussed above, the image may be captured by the camera 39. The image may capture a position of the wiper arm 18 or an actual amount of wiper fluid 64 sprayed.

At block 308, a health of the wiper system 11 is determined in response to the image of the windshield 16 of the vehicle 10. Activating the wiper system 11 may include that actuation of a drive motor 24 of the wiper system 11 is commanded to actuate a wiper arm 1S to a desired actuation position and the image of the windshield 16 of the vehicle 10 captures an actual actuation position of the wiper arm 18. Then the health of the wiper system 11 may be determined in response to the image of the windshield 16 of the vehicle 10 by comparing the actual actuation position of the wiper arm 18 to a desired actuation position and determining a health of the wiper motor 24 in response to comparing the actual actuation position of the wiper arm 18 to a desired actuation position.

Activating the wiper system 11 may include that actuation of a wiper fluid spray system 60 of the wiper system 11 is commanded to spray the windshield 16 with a desired amount of wiper fluid 64 and the image captures an actual amount of wiper fluid sprayed onto the windshield 16. Then the health of the wiper system 11 may be determined in response to the image of the windshield 16 of the vehicle 10 by comparing the actual amount of wiper fluid 64 sprayed onto the windshield 16 to the desired amount of wiper fluid 64 and determining a health of the wiper fluid spray system 60 in response to comparing the actual amount of wiper fluid 64 sprayed onto the windshield 16 to the desired amount of wiper fluid 64.

The image of the windshield 16 of the vehicle 10 captured in block 306 may be captured after the selected period of time, then at block 308 the health of the wiper system 11 or specifically the wiper blade 14 may be determined in response to the image. The health of the wiper system 11 or specifically the wiper blade 14 may be determined in response to the image by determining a visibility through the windshield 16 in response to the image; and comparing the visibility through the windshield 16 to a desired visibility. For example, a healthy wiper system 11 should produce a high level of visibility after the selected period of time (i.e., the time the wiper system 11 is working), whereas non-healthy wiper system 11 will produce a low level of visibility after the selected period of time.

At block 310, a notification is activated in response to the health of the wiper system 11. For example, a notification may be activated on the notification device 50 of FIG. 1. For example, the notification may indicate that a wiper blade 14 should be changed, a drive motor 24 inspected, or wiper fluid 64 refilled.

While the above description has described the flow process of FIG. 3 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of 8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A method of monitoring a windshield of a vehicle, the method comprising:
capturing, using a camera of a windshield monitoring system, an image of a windshield of the vehicle;
determining, using a control module of the windshield monitoring system, that debris is located on the windshield in response to the image of the windshield;
determining, using the control module of the windshield monitoring system, a location of the debris on the windshield, the location of the debris being between a first swipe angle of the wiper arm and a second swipe angle of the wiper arm, wherein a targeted swipe angle from the first swipe angle to the second swipe angle is less than the full swipe angle;
determining, using the control module of the windshield monitoring system, to remove the debris from the windshield; and
actuating using a control module of a wiper control system, a drive motor of the wiper system to actuate the wiper arm only between the first swipe angle and the second swipe angle.

2. (canceled)

3. (canceled)

4. The method of claim 1, wherein determining to remove the debris from the windshield further comprises:
determining using the control module of the windshield monitoring system, a visibility through the windshield in response to the debris detected; and
determining using the control module of the windshield monitoring system, that the visibility through the windshield is less than a desired visibility.

5. The method of claim 1, further comprising:
determining using the control module of the windshield monitoring system, a type of the debris.

6. The method of claim 5, further comprising:
adjusting using the control module of the wiper control system, at least one of speed and duration of the drive motor in response to the type of the debris.

7. The method of claim 5, further comprising:
activating, using the control module of the windshield monitoring system, a heating ventilation and air conditioning system of the vehicle in response to the type of the debris.

8. The method of claim 5, further comprising:
activating, using the control module of the windshield monitoring system, a wiper fluid spray system in response to the type of the debris.

9. The method of claim 1, further comprising:
determining, using the control module of the windshield monitoring system, a size of the debris.

10. The method of claim 9, further comprising at least one of:
adjusting using the control module of the windshield monitoring system, at least one of speed and duration of the drive motor in response to the size of debris; and
activating, using the control module of the windshield monitoring system, a wiper fluid spray system in response to the size of the debris.

11. The method of claim 1, further comprising:
receiving a selection input from an input device to stop actuating the drive motor.

12. The method of claim 1, further comprising:
capturing, using the camera of the windshield monitoring system, a second image of the windshield of the vehicle;
determining, using the control module of the windshield monitoring system, that the debris has been removed from the windshield in response to the second image of the windshield; and
stopping the drive motor of the wiper system.

13. A method of monitoring health of a wiper system of a vehicle, the method comprising:
commanding, using a control module of a windshield monitoring system, actuation of a drive motor to actuate a wiper arm to a desired actuation position, the drive motor being configured to move the wiper arm through the full swipe angle and anywhere therewithin;
capturing, using a camera of the windshield monitoring system, an image of a windshield of the vehicle, wherein the image captures an actual actuation position of the wiper arm;
comparing using the control module of the windshield monitoring system, the actual actuation position of the wiper arm to the desired actuation position;
determining, using the control module of the windshield monitoring system, a health of the wiper motor in response to comparing the actual actuation position of the wiper arm to the desired actuation position; and
activating, using the control module of the windshield monitoring system, a notification in response to the health of the wiper system.

14. (canceled)

15. (canceled)

16. The method of claim 13, further comprising:
commanding, using the control module of the windshield monitoring system, actuation of a wiper fluid spray system of the wiper system to spray the windshield with a desired amount of wiper fluid, wherein the image captures an actual amount of wiper fluid sprayed onto the windshield.

17. The system method of claim 16, wherein determining using the control module of the windshield monitoring system, the health of the wiper system in response to the image of the windshield of the vehicle further comprises:
comparing, using the control module of the windshield monitoring system, the actual amount of wiper fluid sprayed onto the windshield to the desired amount of wiper fluid; and
determining using the control module of the windshield monitoring system, a health of the wiper fluid spray system in response to comparing the actual amount of wiper fluid sprayed onto the windshield to the desired amount of wiper fluid.

18. The method of claim 13, wherein the image of the windshield of the vehicle is captured after the selected period of time, and wherein the method further comprises:
determining, using the control module of the windshield monitoring system, a health of a wiper blade of the wiper system in response to the image.

19. The method of claim 18, wherein
determining the health of a wiper blade of the wiper system in response to the image further comprises:
determining using the control module of the windshield monitoring system, a visibility through the windshield in response to the image; and
comparing, using the control module of the windshield monitoring system, the visibility through the windshield to a desired visibility.

20. The method of claim 13, wherein the image of the windshield of the vehicle is captured after the selected period of time, and wherein determining the health of the wiper system in response to the image of the windshield of the vehicle further comprises:
determining using the control module of the windshield monitoring system, a visibility through the windshield in response to the image; and
comparing using the control module of the windshield monitoring system, the visibility through the windshield to a desired visibility.
